(19) United States
(12) Patent Application Publication
(10) Pub. No.: US 2024/0307976 A1
(43) Pub. Date: Sep. 19, 2024

(54) CHUCK DEVICE AND METHOD FOR ATTACHING CHILD JAWS

(71) Applicant: FUJI CORPORATION, Chiryu (JP)

(72) Inventors: Toshitaka KIMURA, Nisshin-shi (JP); Masaki YASUE, Nisshin-shi (JP)

(73) Assignee: FUJI CORPORATION, Chiryu (JP)

(21) Appl. No.: 18/576,313

(22) PCT Filed: Jul. 12, 2021
(86) PCT No.: PCT/JP2021/026093

§ 371 Date: Jan. 3, 2024

(51) Int. Cl. B23B 31/16

(52) U.S. Cl. CPC B23B 31/16283; B23B 31/16275; B23B 31/16295; B23B 2231/2075

(57) ABSTRACT

A master jaw of the chuck device includes a recessed portion recessed in a direction parallel to an axis of a spindle, and a locking portion provided outside the recessed portion in a direction orthogonal to the axis. The sub jaw includes an insertion member inserted into the recessed portion from a direction parallel to the axis by an elastic force of an elastic member, a plate located on a side opposite to the biasing member in a state of being attached to the master jaw and clamping the master jaw between the plate and the insertion member inserted into the recessed portion, and a locked portion configured to come into contact with and be locked to the locking portion from an inside in a direction orthogonal to the axis in a state in which the insertion member is inserted into the recessed portion.

### TECHNICAL FIELD

The present disclosure relates to a chuck device for gripping a workpiece and a method for attaching sub jaws.

### BACKGROUND ART

Conventionally, various chuck devices for gripping a workpiece have been proposed. For example, Patent Literature 1 below describes a chuck device for gripping an annular workpiece. In the chuck device of Patent Literature 1, an annular workpiece is provided radially outside an axis, and sub jaws are disposed radially outside the workpiece. The sub jaw is attached to the pin of a master jaw so as to be guided, and moves inward in the direction of a radius of the master jaw in accordance with the advancing and retreating movement of the master jaw in the direction of the radius to press the workpiece. The workpiece is gripped between multiple sub jaws and the axis.

### PATENT LITERATURE

Patent Literature 1: JP-A-H01-166008 (FIG. 7)

### BRIEF SUMMARY

### Technical Problem

In the chuck device of Patent Literature 1 described above, the workpiece is gripped by the sub jaws by operating the master jaws to which the sub jaws are attached. In this type of chuck device, the sub jaws are replaced according to the type of the workpiece. Therefore, it is desirable that the sub jaw has a structure that can be attached to the master jaw more easily. Meanwhile, in order to stably grip the workpiece by pressing the workpiece with the sub jaws during rotation or processing of the workpiece, it is desirable to firmly attach the sub jaws to the master jaws.

The present disclosure has been made in view of the above issues, and an object of the present disclosure is to provide a chuck device and a method for attaching a sub jaw, which can reduce the burden of work of replacing a sub jaw attached to a master jaw and can firmly attach the sub jaw to the master jaw.

### Solution to Problem

In order to solve the above issues, the present description discloses a chuck device including a chuck main body configured to rotate about an axis of a spindle, a locator configured to be detachably attached to the chuck main body, a master jaw configured to be attached to the chuck main body, and a sub jaw configured to be detachably attached to the master jaw and to clamp a workpiece brought into contact with the locator from an outside in a direction orthogonal to the axis, in which the master jaw includes, a recessed portion recessed in a direction parallel to the axis, and a locking portion provided outside the recessed portion in a direction orthogonal to the axis, and the sub jaw includes, a biasing member having an elastic member and an insertion member inserted into the recessed portion from a direction parallel to the axis by an elastic force of the elastic member, a plate that is located on a side opposite to the biasing member in a state of being attached to the master jaw and clamps the master jaw between the plate and the insertion member inserted into the recessed portion, and a locked portion configured to come into contact with and be locked to the locking portion from an inside in a direction orthogonal to the axis in a state in which the insertion member is inserted into the recessed portion.

Further, the content of the present disclosure is not limited to the embodiment as a chuck device, and it is advantageous to practice the content as a method for attaching sub jaws in a chuck device.

### Advantageous Effects

According to the chuck device and the method for attaching a sub jaw of the present disclosure, it is possible to reduce the burden of work of replacing a sub jaw attached to a master jaw and to firmly attach the sub jaw to the master jaw.

### BRIEF DESCRIPTION OF DRAWINGS

FIG. 1 is a perspective view of an NC lathe according to the present embodiment.

FIG. 2 is an exploded perspective view of a chuck device.

FIG. 3 is a cross-sectional view and a partially enlarged view of the chuck device which is not disassembled along the line A-A illustrated in FIG. 2.

FIG. 4 is a cross-sectional view illustrating a state in which a locator is removed from an attachment state of FIG. 3.

FIG. 5 is a front view of a master jaw.

FIG. 6 is a perspective view of the master jaw as viewed from the rear side.

FIG. 7 is a side view of the master jaw.

FIG. 8 is a front view of a sub jaw.

FIG. 9 is a perspective view of the sub jaw as viewed from the rear side.

FIG. 10 is an exploded perspective view of the master jaw and the sub jaw.

FIG. 11 is a perspective view illustrating a state in which the sub jaw is inserted into the master jaw in an axial direction.

FIG. 12 is a partial cross-sectional view of the side surface in the state of FIG. 11.

FIG. 13 is a rear view in the state of FIG. 11.

FIG. 14 is a perspective view illustrating a state in which the sub jaw is attached to the master jaw.

FIG. 15 is a partial cross-sectional view and a partially enlarged view of the side surface in the state of FIG. 14.

FIG. 16 is a rear view in the state of FIG. 14.

### DESCRIPTION OF EMBODIMENTS

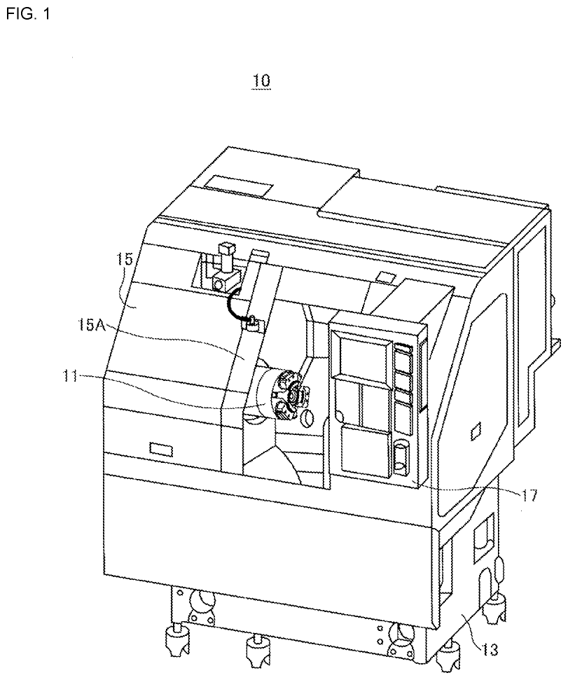

Hereinafter, an embodiment of a chuck device according to the present disclosure will be described with reference to drawings. FIG. 1 is a perspective view of NC lathe 10. NC lathe 10 is an example of a device including the chuck device of the present disclosure. In the present embodiment, an example in which chuck device 11 of NC lathe 10 is embodied as an embodiment in which the chuck device of the present disclosure is embodied will be described. The device including the chuck device according to the present disclosure is not limited to a device such as an NC lathe that automatically processes a workpiece, and may be a general-purpose lathe that is manually operated by a user for processing.

In NC lathe 10, in addition to chuck device 11 for gripping a workpiece, a turret device for holding a tool and a drive mechanism (not illustrated) for moving the turret device along an X axis and a Z axis are provided on bed 13. In NC lathe 10, the above-described devices are covered with body cover 15. Body cover 15 covers an upper portion of bed 13 of NC lathe 10 and accommodates the above-described devices. Slide door 15A is provided at the center of the front surface of body cover 15. Slide door 15A slides in the left-right direction in FIG. 1 to open and close the center of the front surface of body cover 15. A user opens slide door 15A to load and unload a workpiece. Further, as will be described later, the user can replace locator 22 and sub jaw 24 of chuck device 11 by opening slide door 15A. FIG. 1 illustrates a state in which slide door 15A is opened. Slide door 15A may be opened or closed manually by the user or automatically by NC lathe 10. In addition, a workpiece may be manually loaded and unloaded by the user, or may be automatically loaded and unloaded by a loader. Control device 17 is provided next to slide door 15A on the front surface of body cover 15. Control device 17 integrally controls the processing operation and the like of NC lathe 10.

A space for processing a workpiece is formed in body cover 15 with slide door 15A opened. Chuck device 11 is attached to a spindle of NC lathe 10 in the space in which the processing is performed. The workpiece to be processed is gripped and rotated by chuck device 11. The turret device, for example, selects a tool from among multiple tools according to the contents of processing, and performs processing on a workpiece gripped by chuck device 11.

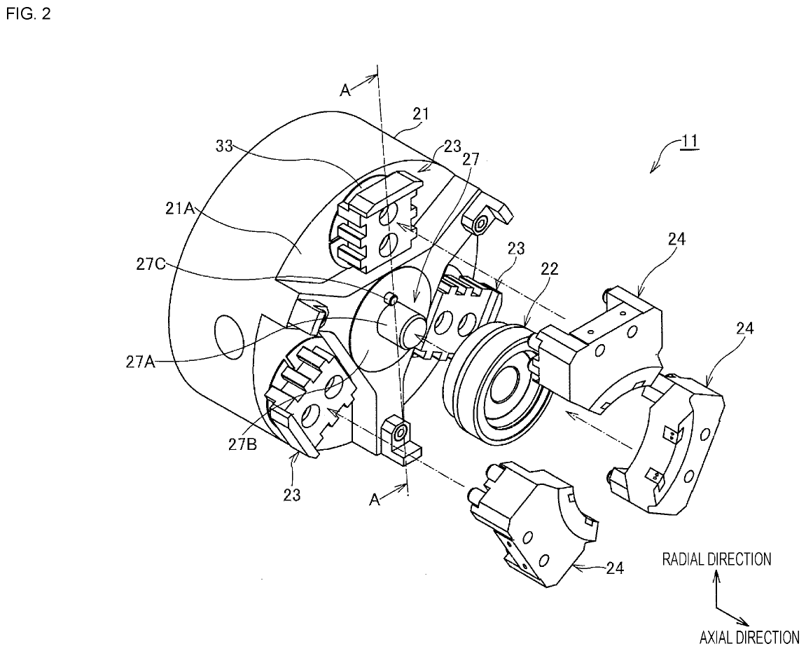

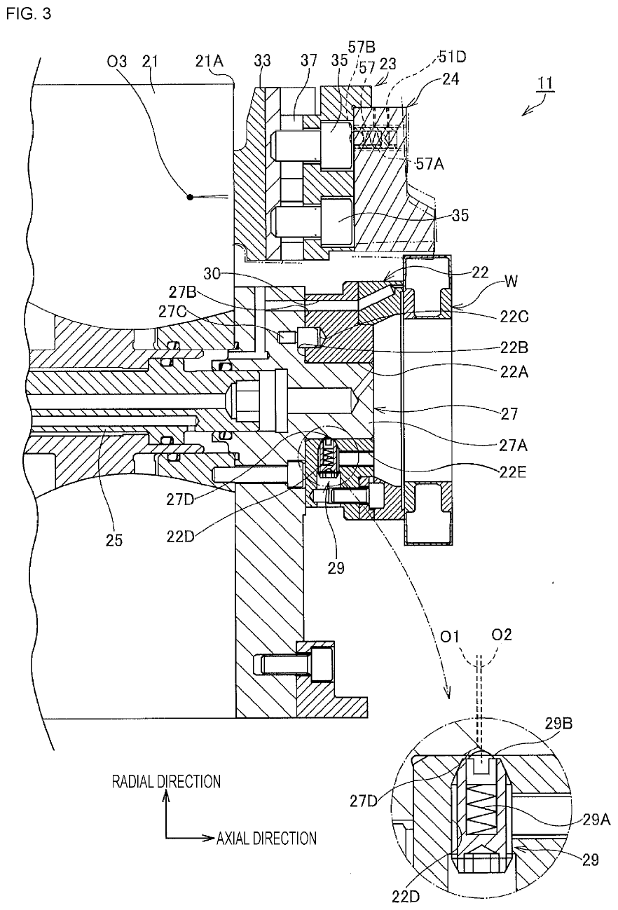

FIG. 2 is an exploded perspective view of chuck device 11. FIG. 3 illustrates a cross-sectional view of chuck device 11 which is not disassembled along the line A-A illustrated in FIG. 2. In the following description, as illustrated in FIGS. 2 and 3, a direction along the axis of the spindle is referred to as an axial direction, and a direction perpendicular to the axial direction is referred to as a radial direction. In chuck device 11, a side attached to NC lathe 10 in the axial direction is referred to as a proximal end side, and a side to which workpiece W (see FIG. 3) is attached is referred to as a distal end side. Further, the respective members such as locator 22 will be described with reference to a state where the respective members are attached to chuck main body 21. FIG. 3 illustrates a state where workpiece W is brought into contact with (installed on) locator 22 from the distal end side in the axial direction.

As illustrated in FIG. 2, chuck device 11 includes chuck main body 21, locator 22, multiple master jaws 23, and multiple sub jaws 24. Chuck main body 21 has a substantially cylindrical shape in a direction along the axis of the spindle, that is, along the axial direction. Chuck main body 21 is attached to spindle 25. Spindle 25 rotates chuck main body 21 about the axis thereof based on the rotation of a spindle motor (not illustrated).

### (Attachment Structure of Locator 22)

Tip surface 21A to which locator 22 and master jaws 23 are attached is formed on the distal end side of chuck main body 21. Tip surface 21A has a circular shape, and locator attachment portion 27 is formed at a central portion, that is, a position along the axis. Locator 22 is attached to locator attachment portion 27. Locator 22 has a substantially circular ring shape and is detachably attached to locator attachment portion 27 of chuck main body 21. Shaft portion 27A is formed at the center of locator attachment portion 27 in the radial direction, that is, at the position of the axis (rotation center). Shaft portion 27A has a cylindrical shape along the axial direction. Insertion hole 22A into which shaft portion 27A is inserted is formed in locator 22. Insertion hole 22A is formed to penetrate through locator 22 along the axial direction, has a circular cross-sectional shape, and is formed such that the length of the inner diameter thereof matches the length of the outer diameter of shaft portion 27A. In a state in which locator 22 is attached to locator attachment portion 27, the inner circumferential surface of insertion hole 22A comes into contact with the outer circumferential surface of shaft portion 27A. Accordingly, in a state in which locator 22 is attached to locator attachment portion 27, the movement in the radial direction is restricted by locator attachment portion 27.

First attachment surface 27B is formed around shaft portion 27A in locator attachment portion 27. First attachment surface 27B faces the distal end side of chuck main body 21 in a direction parallel to the axial direction, and has a circular flat surface. Shaft portion 27A is formed at the center of first attachment surface 27B. Second attachment surface 22B is formed on the proximal end side of locator 22. Second attachment surface 22B faces the proximal end side of the locator 22 in a direction parallel to the axial direction, and has a circular ring shape in which insertion hole 22A is formed in the center. Second attachment surface 22B comes into contact with first attachment surface 27B in a state in which locator 22 is attached to locator attachment portion 27 (chuck main body 21). For example, second attachment surface 22B is in surface contact with entire first attachment surface 27B. Accordingly, in a state in which locator 22 is attached to locator attachment portion 27, movement of locator 22 toward the proximal end side in the axial direction is restricted by locator attachment portion 27.

Further, first attachment surface 27B is provided with positioning member 27C protruding to the distal end side in a direction parallel to the axial direction. Positioning member 27C is, for example, a bolt, is screwed to a screwed portion formed on first attachment surface 27B, and is fixed to first attachment surface 27B in a state in which a head portion protrudes to the distal end side. Positioning member 27C is not limited to a bolt, and may be, for example, a metal member (a protruding portion of metal) integrally formed with locator attachment portion 27 or a pin.

Further, positioning hole 22C is formed in second attachment surface 22B so as to be recessed from the proximal end side toward the distal end side along a direction parallel to the axial direction. Positioning hole 22C has a size capable of accommodating a portion of positioning member 27C protruding from first attachment surface 27B toward the distal end side. In a state in which locator 22 is attached to locator attachment portion 27 and second attachment surface 22B is brought into surface contact with first attachment surface 27B, positioning member 27C is accommodated in positioning hole 22C. Locator 22 need not be in surface contact with locator attachment portion 27. That is, second attachment surface 22B and first attachment surface 27B may be uneven surfaces or spherical surfaces instead of flat surfaces.

Locator 22 is fixed to locator attachment portion 27 by biasing member 29. Specifically, biasing member 29 is attached to locator 22. Biasing member 29 is, for example, a ball plunger, and includes spring 29A and ball 29B biased by an elastic force of spring 29A. Biasing member 29 is an example of a locator side biasing member of the present disclosure. The locator side biasing member of the present disclosure is not limited to a ball plunger, and other plungers such as a pin plunger can be adopted. Further, the locator side biasing member is not limited to a plunger, and various biasing members (leaf springs or the like) that apply a biasing force from locator 22 to main body side recessed portion 27D side of locator attachment portion 27 described later can be adopted.

Biasing member 29 is attached to locator 22 in a state in which ball 29B is directed to the inside (the center side in the radial direction) of locator 22. Biasing member 29 is attached to locator 22, for example, in a posture of biasing ball 29B upward in FIG. 3 by spring 29A. Biasing member 29 has, for example, a male screw formed on an outer circumferential surface thereof, and is screwed and fixed to screwed portion 22D (female screw) formed on locator 22. The position of biasing member 29 relative to locator 22 in the radial direction is adjusted by the amount of screwing. For example, horizontal hole 22E communicating with screwed portion 22D is formed on locator 22. A screw (not illustrated) for preventing loosening of biasing member 29 is screwed into horizontal hole 22E. Biasing member 29 is more firmly fixed in position in the radial direction by the loosening prevention screw.

In addition, main body side recessed portion 27D into which ball 29B of biasing member 29 is inserted is formed in locator attachment portion 27. Main body side recessed portion 27D is, for example, a countersink (recess) formed by performing countersink processing on a part of locator attachment portion 27 made of metal. Main body side recessed portion 27D is formed by providing locator attachment portion 27 to be recessed radially inward. Main body side recessed portion 27D is formed in alignment with the position of biasing member 29. That is, when locator 22 is attached to locator attachment portion 27 by aligning positioning hole 22C with the position of positioning member 27C, main body side recessed portion 27D is formed at a position where ball 29B of biasing member 29 is inserted.

### (Regarding Work of Attaching Locator 22)

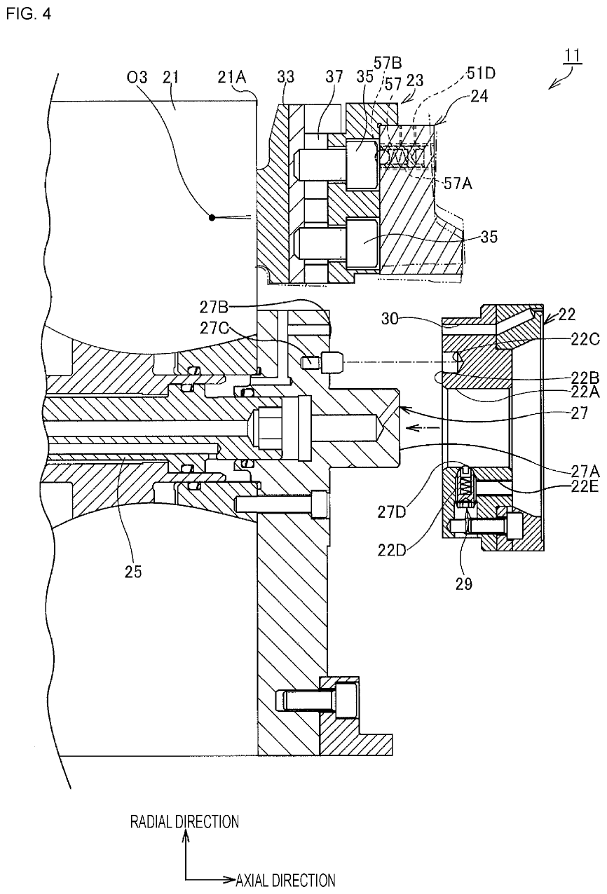

FIG. 4 illustrates a state in which locator 22 is removed from the attachment state of FIG. 3. Since FIG. 4 illustrates a state in which locator 22 is removed, workpiece W in FIG. 3 is not illustrated. As illustrated in FIG. 4, the user attaches locator 22 to locator attachment portion 27 in a state in which the position of positioning member 27C is aligned with the position of positioning hole 22C. The user aligns the positions of positioning member 27C and positioning hole 22C, inserts shaft portion 27A into insertion hole 22A, and attaches locator 22 to locator attachment portion 27. By aligning the positions of positioning member 27C and positioning hole 22C, the positions of biasing member 29 and main body side recessed portion 27D coincide with each other in the circumferential direction. For example, the user inserts locator 22 into locator attachment portion 27 until the user feels in the hand that biasing member 29 is inserted into main body side recessed portion 27D and ball 29B of biasing member 29 enters main body side recessed portion 27D. Biasing member 29 is inserted into main body side recessed portion 27D by the insertion operation of the user. Accordingly, the work of attaching locator 22 is facilitated, and locator 22 can be attached to locator attachment portion 27 at a correct position where biasing member 29 is inserted into main body side recessed portion 27D.

Further, as illustrated in the enlarged view of FIG. 3, in a state in which locator 22 is attached to locator attachment portion 27, biasing member 29 is in a state in which center line O2 of ball 29B is shifted to the distal end side with respect to center line O1 of the recess (countersink) of main body side recessed portion 27D. Center line O1 is, for example, a straight line that passes through the center of main body side recessed portion 27D that is a countersink and is parallel to the radial direction. Center line O2 is, for example, a straight line that passes through the center of spherical ball 29B and is parallel to the radial direction. Accordingly, biasing member 29 presses ball 29B against main body side recessed portion 27D at a position closer to the distal end side than center line O1 of main body side recessed portion 27D. Ball 29B is pressed against the inclined surface of main body side recessed portion 27D that is inclined radially inward from the distal end side toward the proximal end side in the axial direction. Accordingly, locator 22 receives a force (reaction force) to be biased from the inclined surface of main body side recessed portion 27D toward the proximal end side.

Meanwhile, in a state in which locator 22 is attached to locator attachment portion 27, second attachment surface 22B is brought into surface contact with first attachment surface 27B from the distal end side, and is locked by first attachment surface 27B. Accordingly, a portion of first attachment surface 27B at a position facing biasing member 29 in the axial direction functions as a main body side locking portion of the present disclosure. In addition, a part of second attachment surface 22B which comes into contact with first attachment surface 27B which functions as the main body side locking portion functions as a locator side locked portion of the present disclosure.

According to this configuration, shaft portion 27A is sandwiched between the inner wall of insertion hole 22A and ball 29B from both sides in the radial direction so that locator 22 is restricted from moving in the radial direction. Further, in a state in which ball 29B is inserted into main body side recessed portion 27D, locator 22 brings second attachment surface 22B into contact with first attachment surface 27B from the distal end side in the axial direction. Accordingly, locator 22 is restricted from moving in the axial direction. Accordingly, locator 22 can be firmly attached to locator attachment portion 27.

In addition, by shifting center lines O1 and O2 and bringing ball 29B into contact with the inclined surface of main body side recessed portion 27D, ball 29B biased by spring 29A is fitted (dipped) to the center side (deeper side) of main body side recessed portion 27D. Locator 22 receives a reaction force from the inclined surface of main body side recessed portion 27D toward the proximal end side via ball 29B, and presses second attachment surface 22B against first attachment surface 27B. Accordingly, locator 22 is attached to locator attachment portion 27 in a state of receiving a force toward the proximal end side, and is restricted from moving in the axial direction. In accordance with the rotation of chuck main body 21 during processing, locator 22 can be more firmly fixed to locator attachment portion 27.

Further, in the work of attaching locator 22, locator 22 can be attached by attaching locator 22 to locator attachment portion 27 from the distal end side in the axial direction and pushing locator 22 to a position where ball 29B of biasing member 29 is fitted into main body side recessed portion 27D (a position where first and second attachment surfaces 27B and 22B are in surface contact with each other). Accordingly, the user can easily attach locator 22 to locator attachment portion 27 by one touch.

In addition, in the work of removing locator 22, locator 22 can be removed by pulling locator 22 toward the distal end side against the biasing force of spring 29A to a position where ball 29B comes out to the outside of main body side recessed portion 27D. Therefore, even in the work of removing, the user can easily remove locator 22 by one touch. Accordingly, it is possible to easily replace locator 22 with an appropriate metal according to a change in the type of workpiece W or the like.

As described above, the radial position of biasing member 29 is adjusted by the amount of screwing. Accordingly, biasing member 29 can adjust the force with which ball 29B presses main body side recessed portion 27D by spring 29A according to the screwing position. Accordingly, it is possible to adjust the magnitude of the force necessary for the attachment, the fixing force after the attachment, and the force necessary for the removal at the attachment position of biasing member 29, that is, the screwing position.

Locator attachment portion 27 and locator 22 of the present embodiment include, for example, three combinations of main body side recessed portion 27D and biasing member 29. The three sets of locator attachment portion 27 and biasing member 29 are provided, for example, at equal intervals (intervals of 120 degrees) in the circumferential direction of locator 22. Each of the three sets of locator attachment portion 27 and biasing member 29 is provided at a position where ball 29B is fitted into main body side recessed portion 27D when positioning hole 22C is aligned with positioning member 27C. Chuck device 11 may include only one set of combination of main body side recessed portion 27D and biasing member 29, or may include two or four or more sets. Locator 22 may be fixed to locator attachment portion 27 by a bolt or a nut without using biasing member 29. In this case, locator attachment portion 27 need not include main body side recessed portion 27D. Further, although not described in detail, detection hole 30 for blowing compressed air is formed in locator attachment portion 27 and master jaw 23 in order to check whether workpiece W is appropriately attached (seated) to locator 22. NC lathe 10 can determine the seating state of workpiece W based on the back pressure of the compressed air fed into detection hole 30.

### (Regarding the Structure for Attaching Sub Jaws 24)

Next, an attachment structure of sub jaws 24 to master jaws 23 will be described. As illustrated in FIGS. 2 and 3, three jaw attachment portions 33 are provided on tip surface 21A of chuck main body 21. Master jaw 23 is attached to each of three jaw attachment portions 33. Sub jaw 24 is attached to each of three master jaws 23. Accordingly, chuck device 11 of the present embodiment includes three sets of combinations of jaw attachment portions 33, master jaws 23, and sub jaws 24. The three sets of jaw attachment portions 33, master jaws 23, and sub jaws 24 have the same shape and structure. Therefore, in the following description, any set of jaw attachment portions 33 and the like will be described. The sets of jaw attachment portions 33, master jaws 23, and sub jaws 24 may have different structures. The number of sets of jaw attachment portions 33 and the like is not limited to three sets, and may be one set or multiple sets other than three sets.

Three jaw attachment portions 33 are provided at equal intervals (intervals of 120 degrees) in the circumferential direction of chuck main body 21. Accordingly, master jaws 23 and sub jaws 24 are also provided at equal intervals (intervals of 120 degrees) in the circumferential direction. Locator 22 against which workpiece W (see FIG. 3) is pressed (brought into contact) is disposed at the center of three sub jaws 24. Each of three sub jaws 24 moves in the radial direction to clamp workpiece W brought into contact with locator 22 therebetween to chuck (fix) workpiece W in a state in which workpiece W can be processed. Specifically, for example, jaw attachment portion 33, master jaw 23, and sub jaw 24 are so-called ball chucks, and swing around rotation center O3 illustrated in FIG. 3 according to a driving force of a drive mechanism (not illustrated). Jaw attachment portions 33 and the like rotate (swing) clockwise about rotation center O3 illustrated in FIG. 3 to clamp workpiece W, and rotate counterclockwise to release the chuck (see the two-dot chain line in FIG. 3). Rotation center O3 is, for example, the center of a ball (not illustrated) provided in chuck main body 21. Jaw attachment portion 33 or the like is not limited to the ball chuck, and may be configured to slide in the radial direction without swinging.

Master jaw 23 is fixed to jaw attachment portion 33 by, for example, two bolts 35, and swings integrally with jaw attachment portion 33. For example, T-groove nut 37 is attached to jaw attachment portion 33, and bolt 35 is screwed into T-groove nut 37 to fix master jaw 23 to jaw attachment portion 33. A gap (space) corresponding to the height of T-groove nut 37 is formed between master jaw 23 and jaw attachment portion 33 in the axial direction. First and second plates 54 and 55 of sub jaws 24 described later are inserted into the gap. The member that forms the gap between master jaw 23 and jaw attachment portion 33 is not limited to a T-groove nut, and may be a nut having another shape, a washer, a spring, or the like.

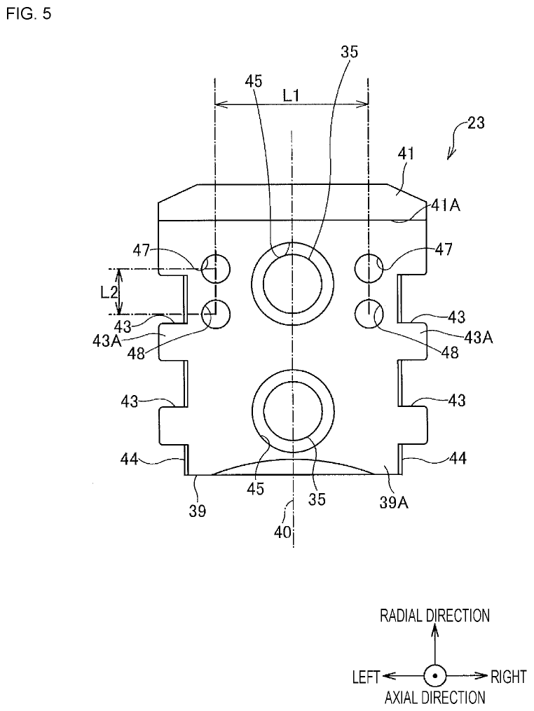

FIG. 5 is a front view of master jaw 23 as viewed from the distal end side in the axial direction. In the following description, as illustrated in FIG. 5, master jaws 23 will be described with reference to the left-right direction when chuck device 11 is viewed from the front in the axial direction. The left-right direction is, for example, a direction parallel to a straight line (a straight line in a tangential direction of cylindrical chuck main body 21) perpendicular to a straight line along a radial direction passing through the axis of chuck main body 21 and the center of master jaw 23. As illustrated in FIGS. 5,6, and 7, master jaw 23 has main body portion 39 and locking portion 41. Master jaw 23 has a line symmetrical shape with respect to straight line 40 passing through the center of master jaw 23 in the left-right direction and extending along the radial direction. Main body portion 39 has a predetermined thickness in the axial direction and has a substantially rectangular plate shape elongated in the radial direction when viewed from one side in the axial direction.

Four recessed grooves 43 are formed on both sides of main body portion 39 in the left-right direction. Two of four recessed grooves 43 are formed on the left side surface, and two of four recessed grooves 43 are formed on the right side surface of main body portion 39. Four recessed grooves 43 are grooves formed by providing main body portion 39 to be recessed inward in the left-right direction, and are formed along a direction parallel to the axial direction. Recessed groove 43 has a rectangular cross-sectional shape elongated in the radial direction when cut along a plane perpendicular to the axial direction. Two recessed grooves 43 formed in the side surface on one side in the left-right direction are formed in parallel to each other with a predetermined distance therebetween in the radial direction.

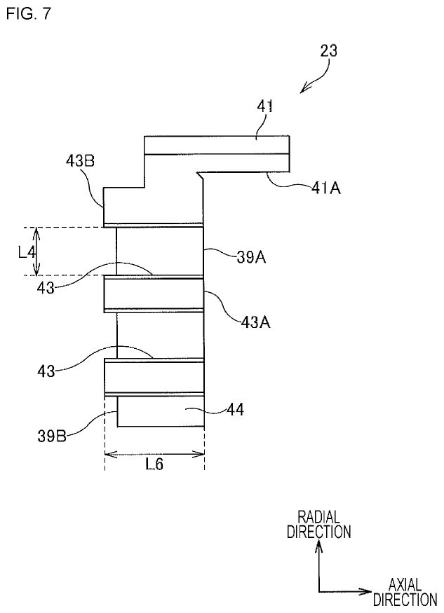

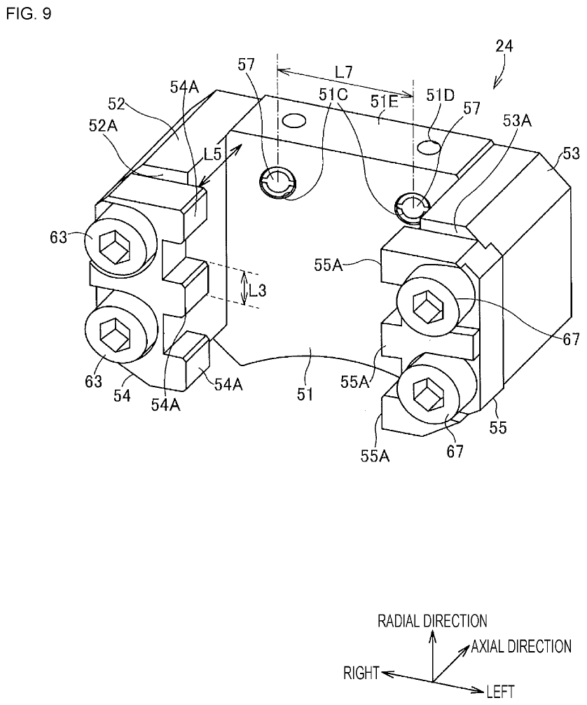

Further, two L-shaped grooves 44 are formed in the inner end portion of master jaw 23 at positions on the inside of recessed groove 43 in the radial direction. Two L-shaped grooves 44 are respectively formed radially inside recessed grooves 43 formed on both sides in the left-right direction. Each of four recessed grooves 43 and two L-shaped grooves 44 is formed to have a size into which ridges 54A and 55A (see FIG. 9) of sub jaws 24 described later can be inserted. Surface 43A on the distal end side of recessed groove 43 is flush with surface 39A on the distal end side of main body portion 39 (see FIG. 7). In addition, a portion of recessed groove 43 other than the bottom portion protrudes toward the proximal end side from surface 39B on the proximal end side of main body portion 39, and a flat surface is formed on surface 43B of the protruded tip (see FIG. 7).

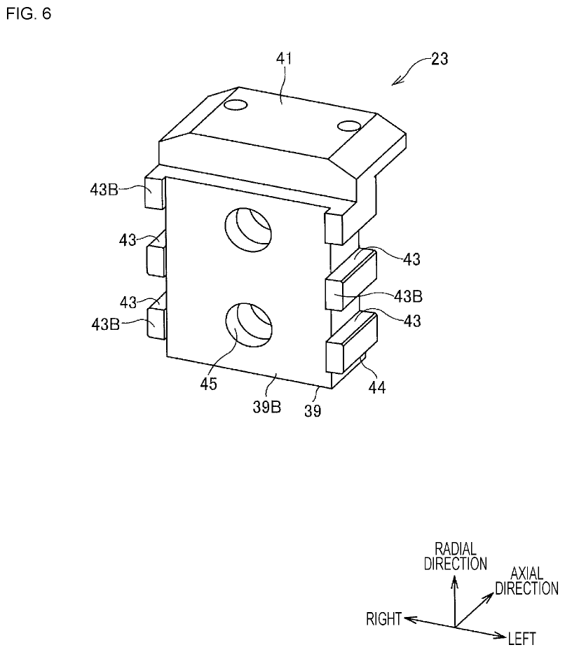

Further, two bolt holes 45 are formed in main body portion 39 at the center in the left-right direction with a predetermined distance therebetween in the radial direction. Two bolt holes 45 penetrate main body portion 39 in the axial direction, and two bolts 35 described above are respectively inserted into two bolt holes 45. In FIGS. 6 and 7, bolts 35 are not illustrated. Two recessed portions 47 and two attachment/detachment recessed portions 48 are formed in main body portion 39. Recessed portion 47 and attachment/detachment recessed portion 48 are, for example, countersinks (recesses) formed by performing countersink processing on a part of main body portion 39 made of metal. Each of two recessed portions 47 and two attachment/detachment recessed portions 48 has, for example, the same shape, and is formed by providing main body portion 39 to be recessed toward the proximal end side in the axial direction. Biasing member 57 of sub jaw 24 described later is inserted into recessed portion 47 and attachment/detachment recessed portion 48.

Two recessed portions 47 are formed at positions sandwiching radially outer bolt hole 45 of two bolt holes 45 in the left-right direction. Similarly, two attachment/detachment recessed portions 48 are formed at positions that sandwich radially outer bolt hole 45 in the left-right direction and that are located on the inside in the radial direction from recessed portions 47. Distance L1 between two recessed portions 47 in the left-right direction is equal to the distance between two attachment/detachment recessed portions 48 in the left-right direction. Further, recessed portions 47 and attachment/detachment recessed portions 48 are formed at positions separated by predetermined distance L2 in the radial direction. As described later, recessed portion 47 is formed at a position where biasing member 57 (see FIG. 9) of sub jaw 24 is inserted in a state in which sub jaw 24 is attached to master jaw 23. Attachment/detachment recessed portion 48 is formed at a position in which biasing member 57 is inserted in a state in which sub jaw 24 is removed from master jaw 23 (a state in which ridges 54A and 55A of first and second plates 54 and 55 described later are inserted into recessed groove 43 and L-shaped groove 44).

Locking portion 41 is integrally formed with the outer end portion of main body portion 39 which is located outside two recessed portions 47 in the radial direction. Locking portion 41 has a substantially plate shape that is thin in the radial direction and protrudes from main body portion 39 toward the distal end side. Locking portion 41 is formed from a first end to a second end of main body portion 39 in the left-right direction. First flat surface 41A is formed radially inside locking portion 41. First flat surface 41A is a flat surface along the left-right direction and the axial direction, and is in contact with second flat surface 51E (see FIG. 9) of sub jaw 24 described later.

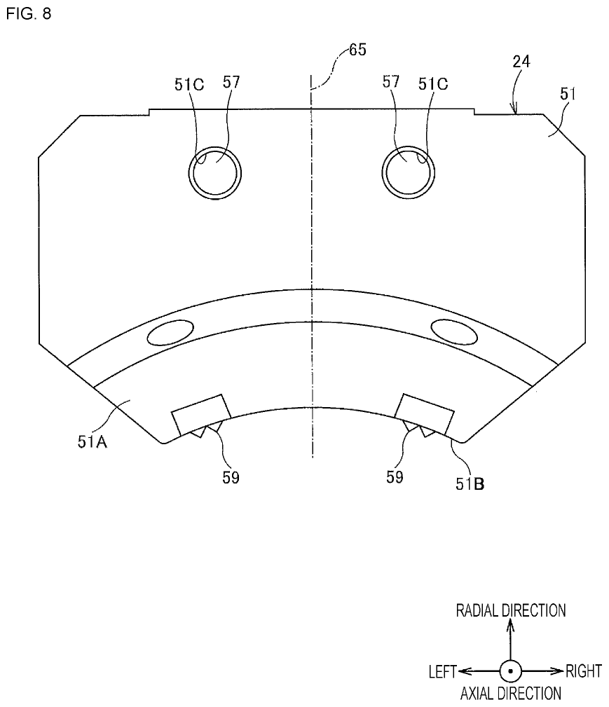

Further, as illustrated in FIGS. 8 and 9, sub jaw 24 includes main body portion 51, first side portion 52, second side portion 53, first plate 54, second plate 55, and two biasing members 57. Sub jaw 24 is configured to be attachable to and detachable from master jaw 23. In a state in which sub jaw 24 is attached to master jaw 23, sub jaw 24 integrally swings together with jaw attachment portion 33 and master jaw 23, and clamps workpiece W (see FIG. 3) brought into contact with locator 22 from the outside in the radial direction. Sub jaws 24 have a shape and structure that are line-symmetrical with respect to straight line 65 (see FIG. 8) that passes through the center in the left-right direction and is parallel to the radial direction.

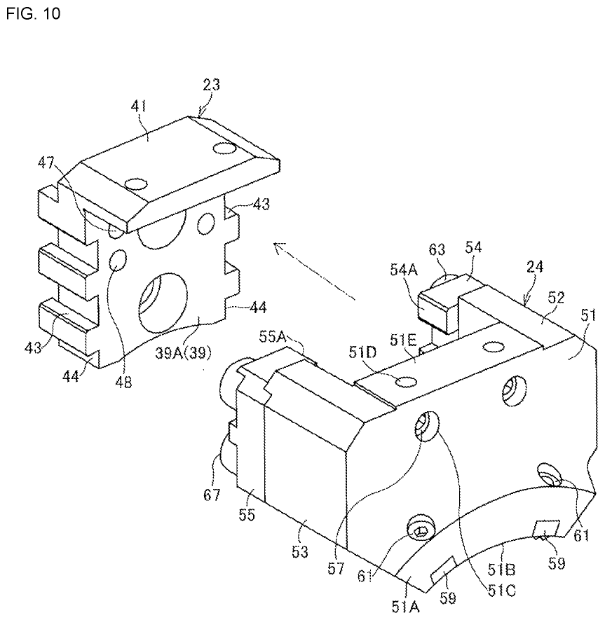

Main body portion 51 has a plate shape having a predetermined thickness in the axial direction. When viewed in the axial direction, a radially outer portion of main body portion 51 has a rectangular shape elongated in the left-right direction, and inner protruding portion 51A is formed in a radially inner portion of main body portion 51. Inner protruding portion 51A protrudes toward the distal end side in the axial direction (see FIG. 10) and has a shape curved radially outward. Two clamping jaws 59 are attached to a radially inner surface of inner protruding portion 51A, that is, curved surface 51B. Each of two clamping jaws 59 is fixed to inner protruding portion 51A by two bolts 61 (see FIG. 10) inserted radially from the outside. Clamping jaw 59 is provided with, for example, multiple protrusions each having a mountain shape with a sharp tip. Clamping jaws 59 clamp workpiece W by bringing the protrusions into contact with workpiece W.

First side portion 52 is formed on the right end portion of main body portion 51. First side portion 52 is formed integrally with main body portion 51 and protrudes toward the proximal end side in the axial direction. First side portion 52 is a plate-shaped member having a predetermined thickness in the left-right direction and having substantially the same length as main body portion 51 in the radial direction. First plate 54 is attached to tip surface 52A on the proximal end side of first side portion 52. First plate 54 is fixed to tip surface 52A by two bolts 63 inserted from the proximal end side in the axial direction.

Three ridges 54A are formed on the inside (left side) of first plate 54 in the left-right direction. Multiple ridges 54A protrude leftward from the left side surface of first plate 54, protrude further leftward from the left side surface of first side portion 52, and are formed at predetermined intervals in the radial direction. Ridge 54A has a substantially rectangular parallelepiped shape elongated in the axial direction. Length L3 of ridge 54A in the radial direction is, for example, slightly shorter than length L4 (groove width, see FIG. 7) of recessed groove 43 in the radial direction. Accordingly, ridge 54A is formed to have a size capable of being inserted into recessed groove 43. Among multiple ridges 54A, two ridges 54A on the outer side in the radial direction are formed in alignment with the positions of recessed grooves 43 formed on the right side of master jaw 23, and are inserted into recessed grooves 43. Further, radially innermost ridge 54A is formed in alignment with position of L-shaped groove 44 formed on the right side of master jaw 23, and is inserted into L-shaped groove 44. Length L3 of radially innermost ridge 54A may be different from length L3 of other ridge 54A.

As described above, sub jaws 24 have a shape and a structure that are line-symmetrical with respect to straight line 65. Therefore, although detailed description of second side portion 53 and second plate 55 will be omitted, second side portion 53 is formed on the left end portion of main body portion 51 and protrudes toward the proximal end side. Second plate 55 is fixed to tip surface 53A of second side portion 53 by two bolts 67. Similarly to ridges 54A, three ridges 55A are formed on the right side of second plate 55. Accordingly, ridges 54A and 55A protrude in directions approaching each other in the left-right direction. Three ridges 55A are inserted into two recessed grooves 43 and L-shaped groove 44 formed on the left side of master jaw 23.

A space surrounded by main body portion 51, first and second side portions 52 and 53, and first and second plates 54 and 55 is formed on the proximal end side of sub jaw 24 in the axial direction. Master jaw 23 is accommodated in the space with sub jaw 24 attached thereto. Distance L5 between first and second plates 54 and 55 (ridges 54A and 55A) and main body portion 51 in the axial direction is, for example, substantially the same as distance L6 (see FIG. 7) between surface 39A on the distal end side of master jaw 23 and surface 43B of recessed groove 43 in the axial direction.

Further, two biasing members 57 are attached to the radially outer portion of main body portion 51. Two biasing members 57 are provided at the same position in the radial direction, are disposed at symmetrical positions across straight line 65, and are provided at positions separated by predetermined distance L7 in the left-right direction. Distance L7 is the same as distance L1 (see FIG. 5) between recessed portion 47 and attachment/detachment recessed portion 48. That is, biasing member 57 is attached in alignment with the positions of recessed portion 47 and attachment/detachment recessed portion 48.

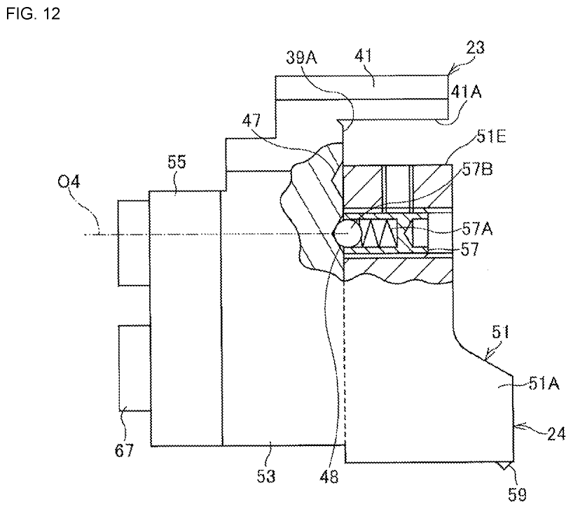

Biasing member 57 is, for example, a ball plunger, and includes spring 57A and ball 57B biased by an elastic force of spring 57A (see FIGS. 3 and 12). The biasing member of the present application is not limited to a ball plunger, and other plungers such as a pin plunger can be adopted. Further, the biasing member is not limited to a plunger, and various biasing members that apply a biasing force from the sub jaw 24 to the master jaw 23 side can be adopted.

Biasing member 57 is attached to main body portion 51 in a state in which ball 57B faces the proximal end side (master jaw 23 side) in the axial direction. Biasing member 57 has, for example, a male screw formed on an outer circumferential surface thereof, and is screwed and fixed to screwed portion 51C (female screw) formed on main body portion 51. The position of biasing member 57 relative to main body portion 51 in the axial direction is adjusted by the amount of screwing. For example, horizontal hole 51D communicating with screwed portion 51C is formed on a radially outer surface (second flat surface 51E described later) of main body portion 51. A screw (not illustrated) for preventing loosening of biasing member 57 is screwed into horizontal hole 51D.

Second flat surface 51E is formed radially outside main body portion 51. Second flat surface 51E is, for example, a flat surface along the axial direction and the left-right direction, and has a rectangular shape having a predetermined width in the axial direction and elongated in the left-right direction. In a state in which sub jaw 24 is attached to master jaw 23, second flat surface 51E comes into surface contact with first flat surface 41A of locking portion 41 of master jaw 23 and is locked. Accordingly, the portion of main body portion 51 where second flat surface 51E is formed functions as the locked portion of the present disclosure.

### (Regarding Work of Attaching Sub Jaw 24)

FIG. 10 is an exploded perspective view of master jaw 23 and sub jaw 24. As illustrated in FIG. 10, the user disposes sub jaws 24 and master jaws 23 to face each other in a direction parallel to the axial direction in a state in which ridges 54A and 55A of first and second plates 54 and 55 are aligned with the positions of recessed grooves 43 and L-shaped grooves 44, respectively. The user attaches sub jaws 24 to master jaws 23 from the distal end side in the axial direction in a state in which sub jaws 24 are disposed to face each other (see the arrow in FIG. 10). When sub jaws 24 are moved toward the proximal end side, each of ridges 54A and 55A is inserted into recessed groove 43 and L-shaped groove 44, respectively.

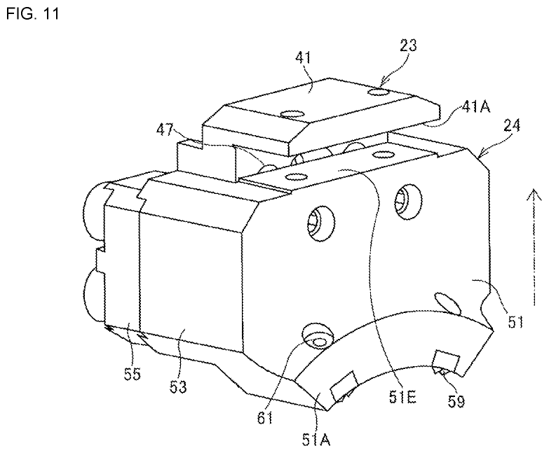

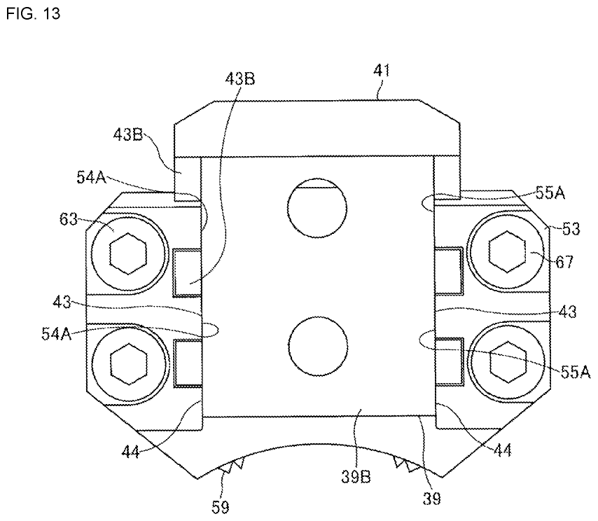

As illustrated in FIGS. 11 to 13, when each of ridges 54A and 55A is inserted into recessed groove 43 and L-shaped groove 44, each of two attachment/detachment recessed portions 48 is located to face each of balls 57B of two biasing members 57 in the axial direction. The user inserts sub jaws 24 into master jaws 23 to positions where ridges 54A and 55A are disposed on the proximal end side in the axial direction with respect to surface 43B of recessed groove 43. For example, the user inserts sub jaw 24 to a position where surface 39A on distal end side of master jaw 23 and the surface on the proximal end side in the axial direction of main body portion 51 come into contact with each other, ball 57B hits attachment/detachment recessed portion 48, and the biasing force of biasing member 57 is felt in the hand. In this state, center line O4 of the recess of attachment/detachment recessed portion 48 coincides with the center line of ball 57B (see FIG. 12). Since surface 43B, and ridges 54A and 55A are disposed at positions shifted in the radial direction (see FIG. 13), sub jaws 24 can be freely moved in the axial direction with respect to master jaws 23, that is, can be removed. Ridges 54A and 55A are inserted into, for example, a gap in the axial direction between master jaw 23 formed by T-groove nut 37 described above and jaw attachment portion 33. Second flat surface 51E of main body portion 51 and first flat surface 41A of locking portion 41 are disposed at positions facing each other with a predetermined gap therebetween in the radial direction. This gap is, for example, the same as distance L2 (see FIG. 5) between recessed portion 47 and attachment/detachment recessed portion 48.

When the user inserts sub jaw 24 into master jaw 23 to the state illustrated in FIGS. 11 to 13, sub jaw 24 is relatively moved radially outward with respect to master jaw 23 (see the arrow in FIG. 11). When ball 57B comes out of attachment/detachment recessed portion 48 in accordance with the movement of sub jaw 24, biasing member 57 presses master jaw 23 (surface 39A) toward the proximal end side in the axial direction by ball 57B due to the biasing force of spring 57A. Further, ridges 54A and 55A of first and second plates 54 and 55 overlap surface 43A of recessed groove 43 from the proximal end side in the axial direction. Accordingly, main body portion 39 of master jaw 23 is sandwiched between ridges 54A and 55A and two biasing members 57 in the axial direction.

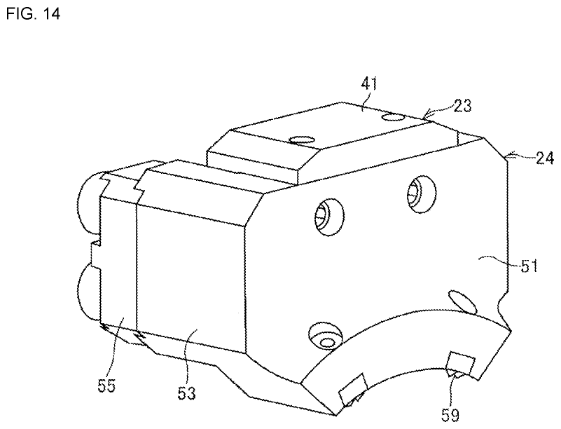

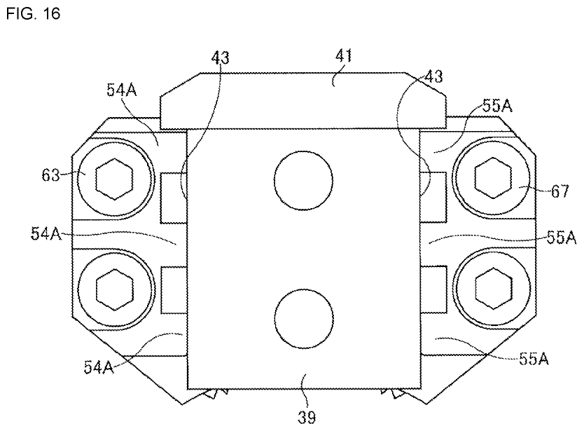

As illustrated in FIGS. 14 to 16, the user moves sub jaw 24 radially outward to a position where ball 57B of biasing member 57 is inserted into recessed portion 47. When biasing member 57 is moved radially outward by distance L2 (see FIG. 5) or a distance slightly shorter than distance L2 from a position where ball 57B is inserted into attachment/detachment recessed portion 48, ball 57B is inserted into recessed portion 47. Ridges 54A and 55A are brought into contact with surface 43A from the proximal end side in the axial direction, main body portion 51 is brought into contact with surface 39A from the distal end side, ball 57B is inserted into recessed portion 47, and sub jaw 24 is in a state of clamping master jaw 23 in the axial direction. Accordingly, first and second plates 54 and 55 are located on the opposite side of biasing member 57 in the axial direction in a state in which sub jaw 24 is attached to master jaw 23, and clamp master jaw 23 between first and second plates 54 and 55 and ball 57B inserted into recessed portion 47. Sub jaws 24 are restricted from moving in the axial direction with respect to master jaws 23. For example, the user moves sub jaws 24 until he or she feels in the hand that ball 57B enters recessed portion 47. Accordingly, the work of attaching sub jaw 24 is facilitated, and sub jaw 24 can be attached to master jaw 23 at a correct position where the biasing member 57 is inserted into the recessed portion 47.

As described above, the sub jaws 24 are moved in the direction parallel to the axial direction by aligning the ridges 54A and 55A with the positions of the recessed grooves 43, and then moved radially outward from the state in which the ridges 54A and 55A are located on the proximal end side of the surface 43B of the recessed groove 43. As a result, recessed portion 47 is formed at a position where ball 57B of biasing member 57 is inserted. In such a configuration, sub jaw 24 can be moved in the axial direction from a position facing master jaw 23 in the axial direction, and then moved in the radial direction to be attached. Therefore, it is not necessary to dispose entire sub jaw 24 radially inside master jaw 23.

Here, it is also possible to adopt a configuration in which entire sub jaw 24 is disposed radially inside master jaw 23, for example, at a position where second flat surface 51E is on locator 22 side with respect to main body portion 39, and then sub jaw 24 is moved radially outward, and biasing member 57 is inserted and attached to recessed portion 47 while master jaw 23 is sandwiched between ridges 54A and 55A and biasing member 57. In this case, master jaw 23 does not need to include recessed groove 43, L-shaped groove 44, and attachment/detachment recessed portion 48. However, since the sub jaw 24 is disposed inside master jaw 23, it is necessary to secure a space in which sub jaw 24 can be inserted between master jaw 23 and locator 22 in the radial direction. In other words, the distance between master jaw 23 and locator 22 in the radial direction is increased. As a result, entire chuck device 11 (for example, length in the radial direction) becomes long.

On the other hand, as described above, by providing recessed groove 43 and the like so that insertion can be performed from the axial direction, it is possible to reduce the size of chuck device 11 while facilitating the work of attaching sub jaws 24. The content of the present disclosure may be a configuration in which sub jaw 24 described above is attached radially from the inside master jaw 23 (a configuration that does not require the work in the axial direction). In this case, as described above, master jaw 23 need not include recessed groove 43, L-shaped groove 44, attachment/detachment recessed portion 48, and the like. Further, first and second plates 54 and 55 may have a shape (a single plate shape) in which the gaps between ridges 54A and 55A are filled, instead of a protruding shape as in ridges 54A and 55A.

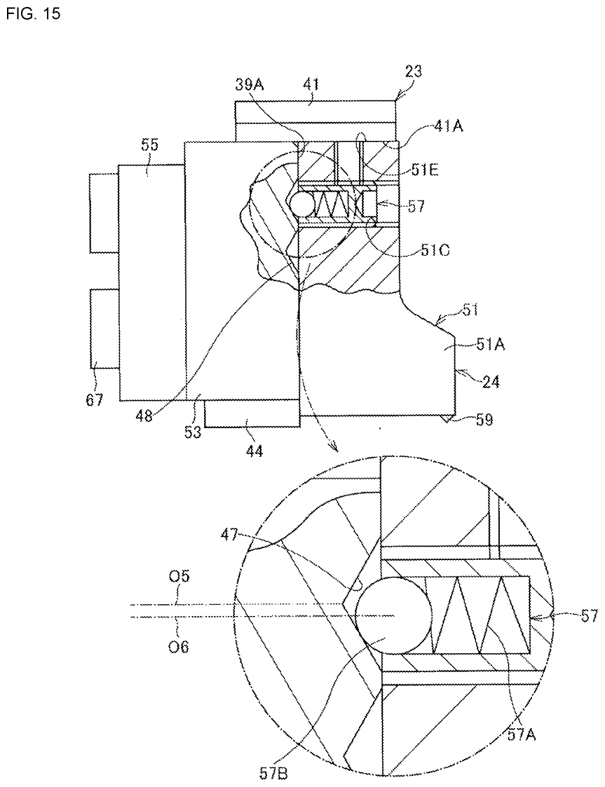

As illustrated in the enlarged view of FIG. 15, in a state in which sub jaw 24 is attached to master jaw 23, biasing member 57 is in a state in which center line O6 of ball 57B is shifted radially inward with respect to center line O5 of the recess (countersink) of recessed portion 47. Center line O5 is, for example, a straight line that passes through the center of recessed portion 47, which is a countersink, and is parallel to the axial direction. Center line O6 is, for example, a straight line that passes through the center of spherical ball 57B and is parallel to the axial direction. Accordingly, biasing member 57 presses ball 57B against recessed portion 47 at a position radially inward from center line O5 of recessed portion 47. Ball 57B is pressed against the inclined surface of recessed portion 47 that is inclined toward the proximal end side in the axial direction from the inside to the outside in the radial direction. Accordingly, sub jaws 24 receive a force (reaction force) that is biased radially outward from the inclined surfaces of recessed portions 47.

On the other hand, in a state in which sub jaw 24 is attached to master jaw 23 (in a state in which ball 57B is inserted into recessed portion 47), sub jaw 24 is locked by bringing second flat surface 51E into surface contact with first flat surface 41A radially from the inside. Accordingly, a portion of main body portion 51 which is located radially outside biasing member 57 functions as a locked portion of the present disclosure. According to this configuration, by shifting center lines O5 and O6 and bringing ball 57B into contact with the inclined surface of recessed portion 47, ball 57B biased by spring 57A is fitted to the center side of recessed portion 47. The sub jaw 24 receives a reaction force radially outward from the inclined surface of the recessed portion 47 via the ball 57B and presses the second flat surface 51E against the first flat surface 41A. Accordingly, sub jaw 24 is attached to master jaw 23 in a state of receiving a force radially outward, and is restricted from moving in the radial direction.

When center lines O5 and O6 temporarily coincide with each other, ball 57B is disposed at the bottom of countersink of recessed portion 47. In this case, ball 57B is in a state in which the biasing force of spring 57A is balanced with the reaction force from the bottom of the countersink. In other words, unlike the case where ball 57B is disposed on the above-described inclined surface, a force for pushing ball 57B radially outward (downward of the inclined surface) does not act. As a result, ball 57B may move radially inward during processing of workpiece W or the like, and sub jaw 24 may move, vibrate, or the like to generate abnormal noise. In contrast, by disposing ball 57B on the above-described inclined surface, it is possible to suppress the movement of ball 57B in the radial direction and to suppress the generation of abnormal noise.

Further, sub jaw 24 is attached to master jaw 23 in a state in which second flat surface 51E is brought into surface contact with first flat surface 41A of locking portion 41. Accordingly, sub jaw 24 can be more stably locked by master jaw 23, and sub jaw 24 can be firmly fixed to master jaw 23. Sub jaws 24 need not be in surface contact with master jaws 23. That is, second flat surface 51E and first flat surface 41A may be uneven surfaces or spherical surfaces instead of flat surfaces.

In addition, master jaw 23 is accommodated in a space surrounded by main body portion 51, first and second side portions 52 and 53, and first and second plates 54 and 55. The side surfaces of master jaws 23 in the left-right direction, that is, the surfaces of the non-recessed portions of recessed grooves 43 are in close contact with the inner circumferential surfaces of first and second side portions 52 and 53 or face each other in the left-right direction with a slight gap therebetween. Accordingly, sub jaws 24 are restricted from moving in the left-right direction with respect to master jaws 23. That is, the relative movement of sub jaw 24 with respect to master jaw 23 is restricted. Sub jaws 24 can be more firmly fixed to master jaws 23 with respect to the rotation of chuck main body 21 during processing.

Further, in the attachment work of sub jaw 24, as described above, sub jaw 24 can be attached by aligning ridges 54A, 55A, and the like with the positions of recessed grooves 43, and the like, and moving sub jaw 24 in the axial direction to a position where ball 57B of biasing member 57 is inserted into attachment/detachment recessed portion 48, and then further sliding sub jaw 24 radially outward to a position where ball 57B is fitted into recessed portion 47 (a position where first and second flat surfaces 41A and 51E are in surface contact). Accordingly, the user can easily attach sub jaws 24 to master jaws 23.

Further, in the work of removing sub jaw 24, sub jaw 24 is slid radially inward against the biasing force of spring 57A to a position where ball 57B exits from recessed portion 47 and is inserted into attachment/detachment recessed portion 48, that is, a position illustrated in FIGS. 11 to 13. Accordingly, sub jaw 24 can be moved to a position where sub jaw 24 can be removed from master jaw 23. The user can easily remove sub jaws 24 from master jaws 23 by moving sub jaws 24 toward the distal end side in the axial direction while inserting ridges 54A and 55A into recessed grooves 43 and the like. Accordingly, sub jaw 24 can be easily replaced with an appropriate sub jaw according to a change in the type of workpiece W or the like.

Accordingly, attachment/detachment recessed portion 48 is formed at a position where ball 57B is inserted in a state in which ridges 54A and 55A are aligned with the positions of recessed grooves 43 and the like. According to this configuration, when sub jaws 24 are moved radially inward from the attachment state, by fitting biasing member 57 into attachment/detachment recessed portion 48, the biasing force changes, and the user can recognize that biasing member 57 has moved to the removal position by feeling in the hand. That is, by providing the attachment/detachment recessed portion 48, the user can easily recognize the removal position where the positions of ridges 54A and 55A and recessed groove 43 and the like are matched, and the work of removing the sub jaws 24 is facilitated. As a result, the time required for replacing sub jaws 24 can be shortened.

Further, as described above, the position of biasing member 57 in the axial direction is adjusted by the amount by which biasing member 57 is screwed into screwed portion 51C, and spring 57A adjusts the force with which ball 57B presses master jaw 23 (recessed portion 47, attachment/detachment recessed portion 48, and the like) depending on the screwing position. Accordingly, it is possible to adjust the magnitude of the force necessary for the attachment, the fixing force after the attachment, and the force necessary for the removal at the attachment position of biasing member 57, that is, the screwing position.

First attachment surface 27B is an example of a main body side locking portion. Second attachment surface 22B is an example of a locator side locked portion. Biasing member 29 is an example of a locator side biasing member. Spring 29A is an example of a locator side elastic member. Ball 29B is an example of a locator side insertion member. First and second plates 54 and 55 are examples of plates. Spring 57A is an example of an elastic member. Ball 57B is an example of an insertion member.

As described above, according to the present example described above, the following advantageous effects can be achieved.

In an aspect of the present example, chuck device 11 includes chuck main body 21, locator 22, master jaw 23, and sub jaw 24. Chuck main body 21 rotates by the spindle 25 about the axis of spindle. Locator 22 is detachably attached to chuck main body 21. Sub jaw 24 is detachably attached to master jaw 23 attached to chuck main body 21, and clamps workpiece W in contact with locator 22 radially from the outside. Master jaw 23 includes recessed portion 47 recessed in a direction parallel to the axial direction, and locking portion 41 provided outside recessed portion 47 in the radial direction. Biasing member 57 attached to sub jaw 24 includes spring 57A, and ball 57B inserted into recessed portion 47 from a direction parallel to the axial direction by an elastic force of spring 57A. Each of first and second plates 54 and 55 of sub jaw 24 is located on the opposite side of biasing member 57 in the axial direction in a state in which sub jaw 24 is attached to master jaw 23, and clamps master jaw 23 between first and second plates 54 and 55 and ball 57B inserted into recessed portion 47. Second flat surface 51E of main body portion 51 comes into contact with and is locked to locking portion 41 radially from the inside in a state in which ball 57B is inserted into recessed portion 47.

According to this configuration, sub jaw 24 can be attached to master jaw 23 by using biasing member 57 in which ball 57B advances and retreats by spring 57A. For example, by moving sub jaw 24 relatively to master jaw 23 radially from the inside toward the outside, ball 57B is fitted into recessed portion 47, and sub jaw 24 can be attached to master jaw 23. Sub jaw 24 is restricted from moving in the axial direction by sandwiching master jaw 23 between first and second plates 54 and 55 and ball 57B from both sides in the axial direction. In addition, sub jaw 24 brings second flat surface 51E into contact with locking portion 41 radially from the inside in a state in which ball 57B is inserted into recessed portion 47. Accordingly, sub jaws 24 are restricted from moving in the radial direction. Accordingly, sub jaws 24 can be firmly attached to master jaws 23.

On the other hand, when removing sub jaw, for example, sub jaw 24 can be removed by moving sub jaw 24 radially inward with respect to master jaw 23 against the biasing force of biasing member 57. That is, sub jaws 24 can be attached to and detached from master jaws 23 by one touch. Accordingly, it is possible to reduce the load of the work of replacing sub jaws 24 attached to master jaws 23.

The present disclosure is not limited to the above-described example, and it is needless to say that various improvements and changes can be made without departing from the gist of the present disclosure.

For example, in the above-described embodiment, chuck device 11 is a so-called triple jaw type chuck device, but is not limited thereto. For example, a collet chuck in which positioning member 27C and main body side recessed portion 27D are provided in locator attachment portion 27 and positioning hole 22C and biasing member 29 are provided on locator 22 side may be used.

The recessed portion or the main body side recessed portion of the present disclosure is not limited to a countersink, and may be a vertically long or horizontally long hole.

Further, the shape and the number of the members in the above embodiment are merely examples. For example, the number of combinations of master jaws 23 and sub jaws 24 may be one, two, or four or more. Further, two or more positioning members 27C may be provided, or only one biasing member 57 may be provided for one sub jaw 24, or three or more biasing members 57 may be provided. Further, only one biasing member 29 may be provided on locator 22, or two or more biasing members 29 may be provided. Sub jaw 24 may include one of first and second plates 54 and 55 (ridges 54A and 55A). The number of ridges 54A and 55A may be one.

Further, in the above-described embodiment, the direction of the axis of the spindle of chuck device 11 is parallel to the installation surface of the device, but the direction is not limited thereto. For example, the direction of the axis may be a direction perpendicular to the installation surface. Further, the machine tool including chuck device 11 is not limited to a lathe. Accordingly, the device including the chuck device of the present disclosure may be, for example, a horizontal lathe, a front lathe, a vertical lathe, a single-axis lathe, a biaxial lathe, a milling machine, a ball machine, or the like.

### REFERENCE SIGNS LIST

11 chuck device, 21 chuck main body, 22 locator, 22A insertion hole, 22B second attachment surface (locator side locked portion), 22C positioning hole, 23 master jaw, 24 sub jaw, 27A shaft portion, 27B first attachment surface (main body side locking portion), 27C positioning member, 27D main body side recessed portion, 29 biasing member (locator side biasing member), 29A spring (locator side elastic member), 29B ball (locator side insertion member), 41A first flat surface, 43 recessed groove, 47 recessed portion, 48 attachment/detachment recessed portion, 51E second flat surface (locked portion), 54 first plate (plate), 55 second plate (plate), 57 biasing member, 57A spring (elastic member), 57B ball (insertion member), W workpiece

1. A chuck device comprising:
a chuck main body configured to rotate about an axis of a spindle;
a locator configured to be detachably attached to the chuck main body;
a master jaw configured to be attached to the chuck main body; and
a sub jaw configured to be detachably attached to the master jaw and to clamp a workpiece brought into contact with the locator from an outside in a direction orthogonal to the axis, wherein
the master jaw includes,
a recessed portion recessed in a direction parallel to the axis, and
a locking portion provided outside the recessed portion in a direction orthogonal to the axis, and
the sub jaw includes,
a biasing member having an elastic member and an insertion member inserted into the recessed portion from a direction parallel to the axis by an elastic force of the elastic member,
a plate that is located on a side opposite to the biasing member in a state of being attached to the master jaw and clamps the master jaw between the plate and the insertion member inserted into the recessed portion, and
a locked portion configured to come into contact with and be locked to the locking portion from an inside in a direction orthogonal to the axis in a state in which the insertion member is inserted into the recessed portion.

2. The chuck device according to claim 1, wherein
the master jaw includes a recessed groove formed in a direction parallel to the axis,
the plate includes a ridge formed in a size capable of being inserted into the recessed groove, and
the recessed portion is formed at a position where the insertion member is inserted when the ridge is moved in a direction parallel to the axis in alignment with a position of the recessed groove and the sub jaw is moved outward in a direction orthogonal to the axis from a state in which the plate is located on a proximal end side of the chuck main body with respect to the recessed groove.

3. The chuck device according to claim 2, wherein
the master jaw includes an attachment/detachment recessed portion inside the recessed portion in a direction orthogonal to the axis, and
the attachment/detachment recessed portion is recessed in a direction parallel to the axis, and is formed at a position where the insertion member is inserted in a state in which the ridge of the plate is aligned with the position of the recessed groove in a direction orthogonal to the axis.

4. The chuck device according to claim 1, wherein
the recessed portion is a countersink recessed in a direction parallel to the axis, and
the sub jaw is attached to the master jaw in a state in which the insertion member is pressed by the elastic member to a position inside a center of the countersink in a direction orthogonal to the axis and the locked portion is in contact with the locking portion.

5. The chuck device according to claim 4, wherein
the locking portion includes a first flat surface inside in a direction orthogonal to the axis,
the locked portion includes a second flat surface outside in a direction orthogonal to the axis, and
the sub jaw is attached to the master jaw in a state in which the second flat surface of the locked portion is brought into surface contact with the first flat surface of the locking portion.

6. The chuck device according to claim 1, wherein
the biasing member is a ball plunger, has a ball as the insertion member, and is screwed and attached to the sub jaw, and a force with which the ball presses the recessed portion by the elastic force of the elastic member is adjusted depending on a screwing position.

7. The chuck device according to claim 1, wherein
the chuck main body includes,
a shaft portion,
a main body side recessed portion recessed inward in a direction orthogonal to the axis, and
a main body side locking portion provided closer to a proximal end side of the chuck main body from the main body side recessed portion in a direction parallel to the axis, and
the locator includes,
an insertion hole into which the shaft portion is inserted,
a locator side biasing member having a locator side elastic member and a locator side insertion member inserted into the main body side recessed portion from a direction orthogonal to the axis by an elastic force of the locator side elastic member, and
a locator side locked portion configured to come into contact with and be locked to the main body side locking portion from a distal end side of the chuck main body in a direction parallel to the axis in a state in which the shaft portion is inserted into the insertion hole and the locator side insertion member is inserted into the main body side recessed portion.

8. The chuck device according to claim 7, wherein
the chuck main body includes a first attachment surface provided around the shaft portion and facing the distal end side of the chuck main body in a direction parallel to the axis,
the locator includes a second attachment surface configured to come into contact with the first attachment surface in a state of being attached to the chuck main body,
the first attachment surface is provided with a positioning member protruding toward the distal end side of the chuck main body in a direction parallel to the axis, and
the second attachment surface is provided with a positioning hole recessed in a direction parallel to the axis and into which the positioning member is inserted in a state in which the locator is attached to the chuck main body.

9. A method for attaching a sub jaw in a chuck device including
a chuck main body configured to rotate about an axis of a spindle,
a locator configured to be detachably attached to the chuck main body,
a master jaw configured to be attached to the chuck main body, and
a sub jaw configured to be detachably attached to the master jaw and to clamp a workpiece brought into contact with the locator from an outside in a direction orthogonal to the axis, in which
the master jaw includes,
a recessed portion recessed in a direction parallel to the axis, and
a locking portion provided outside the recessed portion in a direction orthogonal to the axis, and
the sub jaw includes,
a biasing member having an elastic member and an insertion member to which an elastic force of the elastic member is applied,
a plate, and
a locked portion,
the method comprising:
a step of disposing the master jaw between the plate and the biasing member in a direction parallel to the axis; and
a step of sliding the sub jaw outward in a direction orthogonal to the axis with respect to the master jaw in a state in which the master jaw is disposed between the plate and the biasing member, inserting the insertion member into the recessed portion from a direction parallel to the axis by an elastic force of the elastic member, clamping the master jaw between the insertion member inserted into the recessed portion and the plate, and bringing the locked portion into contact with the locking portion from an inside in a direction orthogonal to the axis to lock the locked portion.
